(19) United States
(12) Patent Application Publication
(10) Pub. No.: US 2026/0244555 A1
(43) Pub. Date: Aug. 20, 2026

(54) Memory Compatibility Layer for API Capture and Replay

(71) Applicant: Google LLC, Mountain View, CA (US)

(72) Inventor: Sahin Serdar Kocdemir, New Malden (GB)

(21) Appl. No.: 19/162,549

(22) PCT Filed: Mar. 6, 2023
(86) PCT No.: PCT/US2023/063773

§ 371 Date: Sep. 5, 2025

(51) Int. Cl. G06F 11/362; G06F 11/3668; G06F 11/3698

(52) U.S. Cl. CPC G06F 11/3636; G06F 11/3696; G06F 11/3698

(57) ABSTRACT

A method is directed to detecting, by a memory compatibility layer running on a device capturing digital content for replay, a call directed to an application programming interface, wherein the call specifies a memory allocation based on the device, wherein the device corresponds to one of a plurality of device types. The method further includes in response to the detected call, retrieving, by the memory compatibility layer, a. maximum memory allocation from a plurality of memory allocations associated with the application programming interface, wherein the plurality of memory allocations correspond to the plurality of device types. The method includes adjusting, by the memory compatibility layer, a response from the application programming interface to accommodate the maximum memory allocation from the plurality of memory allocations. The method additionally includes generating a portable trace for replay of the digital content on a replay device of one of the plurality of device types.

### BACKGROUND

Testing and debugging of software available on many modern computing devices involves the capture of digital content for replay and subsequent recreation on a different computing device. Each of the computing devices often reflects different hardware capabilities and software requirements that make replay between different computing devices unreliable. For example, recreating the captured digital content is difficult due to the different memory requirements associated with different computing devices.

### SUMMARY

In an embodiment, a method is directed to detecting, by a memory compatibility layer running on a device capturing digital content for replay, a call directed to an application programming interface (API), where the call specifies a memory allocation based on the device, where the device corresponds to one of a plurality of device types. The method further includes in response to the detected call, retrieving, by the memory compatibility layer, a maximum memory allocation from a plurality of memory allocations associated with the application programming interface, where the plurality of memory allocations correspond to the plurality of device types. The method includes adjusting, by the memory compatibility layer, a response from the application programming interface to accommodate the maximum memory allocation from the plurality of memory allocations. The method additionally includes generating a portable trace for replay of the digital content on a replay device of one of the plurality of device types.

Another embodiment includes a device, comprising at least one processor configured to execute instructions stored in a memory of the device, where the instructions are executable to detect, by a memory compatibility layer running on the device, a call directed to an application programming interface, where the call specifies a memory allocation based on the device, where the device corresponds to one of a plurality of device types. In response to the detected call, the instructions are executable to retrieve, by the memory compatibility layer, a maximum memory allocation from a plurality of memory allocations associated with the application programming interface, where the plurality of memory allocations correspond to the plurality of device types. The instructions are further executable to adjust, by the memory compatibility layer, a response from the application programming interface to accommodate the maximum memory allocation from the plurality of memory allocations. Based on the adjusted response from the application programming interface, the instructions are executable to generate a portable trace for replay of the digital content on a replay device of one of the plurality of device types.

A further embodiment includes a non-transitory computer readable medium storing program instructions executable by one or more processors to cause the one or more processors to perform operations. The operations include detecting, by a memory compatibility layer running on a device capturing digital content for replay, a call directed to an application programming interface, where the call specifies a memory allocation based on the device, where the device corresponds to one of a plurality of device types. The operations further include, in response to the detected call, retrieving, by the memory compatibility layer, a maximum memory allocation from a plurality of memory allocations associated with the application programming interface, where the plurality of memory allocations correspond to the plurality of device types. The operations additionally include adjusting, by the memory compatibility layer, a response from the application programming interface to accommodate the maximum memory allocation from the plurality of memory allocations. The operations also include, based on the adjusted response from the application programming interface, generating a portable trace for replay of the digital content on a replay device of one of the plurality of device types.

An additional embodiment is a system that includes means for detecting, by a memory compatibility layer running on a device capturing digital content for replay, a call directed to an application programming interface, where the call specifies a memory allocation based on the device, where the device corresponds to one of a plurality of device types. The system further includes means for, in response to the detected call, retrieving, by the memory compatibility layer, a maximum memory allocation from a plurality of memory allocations associated with the application programming interface, where the plurality of memory allocations correspond to the plurality of device types. The system additionally includes means for adjusting, by the memory compatibility layer, a response from the application programming interface to accommodate the maximum memory allocation from the plurality of memory allocations. The system also includes means for, based on the adjusted response from the application programming interface, generating a portable trace for replay of the digital content on a replay device of one of the plurality of device types.

The foregoing summary is illustrative only and is not intended to be in any way limiting. In addition to the illustrative aspects, embodiments, and features described above, further aspects, embodiments, and features will become apparent by reference to the figures and the following detailed description and the accompanying drawings.

### BRIEF DESCRIPTION OF THE DRAWINGS

FIG. 1 illustrates an example computing device, in accordance with example embodiments.

FIG. 2 is a simplified block diagram showing some of the components of an example computing system.

FIG. 3 is a diagram illustrating API communications between multiple applications within a computing device.

FIG. 4 is a diagram illustrating API communications and memory allocation according to an embodiment as described herein.

FIG. 5 is a diagram illustrating API communications and memory allocation according to another embodiment as described herein.

FIG. 6 is a flowchart illustrating a memory allocation according to an embodiment as described herein.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless indicated as such. Other embodiments can be utilized, and other changes can be made, without departing from the scope of the subject matter presented herein.

Thus, the example embodiments described herein are not meant to be limiting. It will be readily understood that the aspects of the present disclosure, as generally described herein, and illustrated in the figures, can be arranged, substituted, combined, separated, and designed in a wide variety of different configurations.

Throughout this description, the articles “a” or “an” are used to introduce elements of the example embodiments. Any reference to “a” or “an” refers to “at least one,” and any reference to “the” refers to “the at least one,” unless otherwise specified, or unless the context clearly dictates otherwise. The intent of using the conjunction “or” within a described list of at least two terms is to indicate any of the listed terms or any combination of the listed terms.

The use of ordinal numbers such as “first,” “second,” “third” and so on is to distinguish respective elements rather than to denote a particular order of those elements. For the purpose of this description, the terms “multiple” and “a plurality of” refer to “two or more” or “more than one.”

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment. In the figures, similar symbols typically identify similar components, unless context dictates otherwise. Further, unless otherwise noted, figures are not drawn to scale and are used for illustrative purposes only. Moreover, the figures are representational only and not all components are shown. For example, additional structural or restraining components might not be shown.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

### I. OVERVIEW

The capture and replay of digital content involving API calls typically requires interception and recording of all the API calls made during capture time. However, there can be a substantial dependency on memory operations with many such APIs. One such example is the graphics API, Vulkan, which has been introduced by the Khronos Consortium as a modular API that is intended to take advantage of current graphics processing units (GPUs). Vulkan allows for the management of GPU memory allocations and uploading data to the GPU, or modifying the memory allocations with various API calls. When these commands are captured, they will only be valid as long as all the memory operations use the same memory addresses, which cannot be enforced on many platforms. In addition, different hardware will have different memory requirements, such as size and alignment of the memory allocation to be made for particular objects. These issues make it difficult to implement a portable trace format that can be reused on different types of replay devices. For instance, it may be difficult to capture Vulkan calls on one device and replay the calls on another device because memory requirements for the buffers and textures with the same creation information will actually change due to driver and hardware differences.

Proposed herein is a system to create a layer for an API, which will help generate compatibility rules for the memory requirements by aggregating responses from multiple devices. Any API call to be used to compute memory requirements of an operation will go through this layer and the results returned will be modified to make the allocations portable among the selected devices. This approach will ensure, during replay time, there will be no memory space collisions due to invalid portability even though the replay will be done without any modifications to actual device memory requirements.

As an illustrative example, in Vulkan API, memory for ‘aBuffer’ is allocated and bound as follows:

{
// Get memory requirements, ie. size, alignment and memorytype
information
VkMemoryRequirements mem.Requirements;
vkGetBufferMemoryRequirements(device, aBuffer, &memRequirements);
// Allocate the memory
VkMemoryAllocateInfo allocationInfo = { ... }
allocInfo.allocationSize = memRequirements.size; // set size based on
requirements of the device
VkDeviceMemory aBufferMemory;
vkAllocateMemory(device, &allocInfo, nullptr, &aBufferMemory);
// Bind the memory to the buffer
vkBindBufferMemory(device, aBuffer, aBufferMemory, 0);
}

When these instructions are run under different devices, ‘memRequirements.size’ can be, for example, 2 megabytes (MB) for device A, but 3 MB for device B. After this point, the address space can be used entirely differently between the devices, which would cause issues with capturing and replaying the memory changes. Examples proposed herein include using a memory compatibility layer on calls like ‘vkGetBufferMemoryRequirements’ to ensure that the size and requirements will be satisfied for all replay devices for which compatibility is needed.

Some example implementations described herein include using maximum size and alignment for all of the memory allocations by creating a table which maps object information to memory requirements. Accordingly, the same object creation information will result in the same memory requirements among all the devices. Such examples may depend on memory allocations being known or determined in advance so that the table can be filled with the matching requirements.

Further example implementations described herein include retrieving source code or decision trees for the implementation of calls like ‘vkGetBufferMemoryRequirements’ from drivers or libraries, and merging all the rules to create compatible decision trees among all the replay devices to be supported. This approach effectively involves merging the code of different implementations to make sure the results are compatible. Such an approach may avoid the need to create and use large tables to decide which type of object should use what type of memory requirements.

Changes may therefore be made for the memory requirement calculations to make sure a compatible memory will be allocated and used at capture time. So, in the previously described Vulkan example, during capture time, the device may allocate 3 MB of memory for the buffer, and memory address space collision issues will be avoided. At replay time, device A can still allocate 2 MB of memory with its own memory alignment rules and the overall memory usage will not change.

Examples are described herein in reference to graphics APIs and Vulkan, including in the context of creating portable traces for the capture and replay of video game content. However, the described methodologies can also be used with different types of APIs that require memory translation layers. Another example is the implementation of one or more machine-learned models, such as API calls indicating amounts of memory to execute a particular type of model or a particular layer of a model. Other examples involving memory allocation for GPU-related computations are also contemplated.

### II. EXAMPLE SYSTEMS

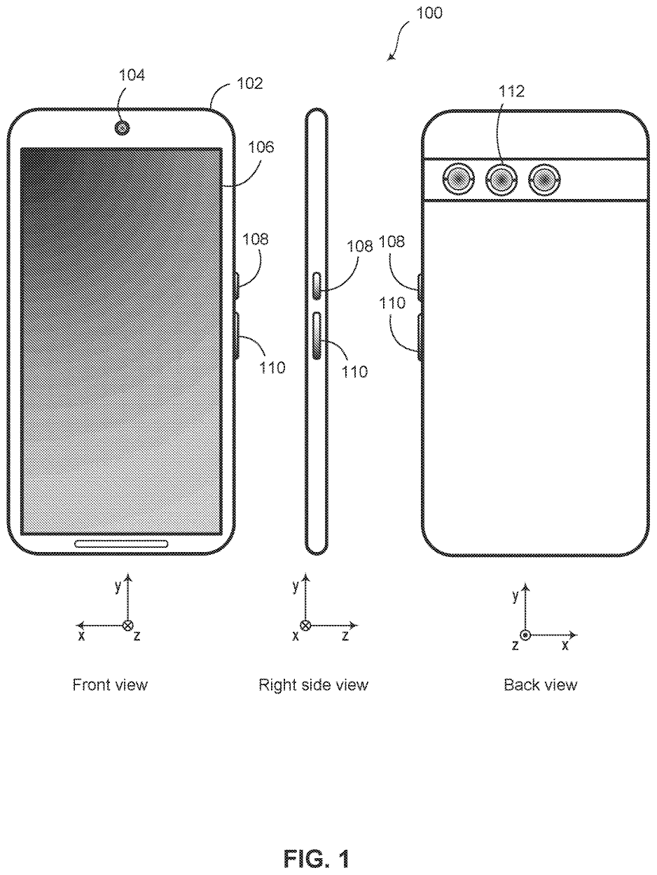

FIG. 1 illustrates an example computing device 100. Computing device 100 is shown in the form factor of a mobile phone. Computing device 100 may be one mobile phone model of a particular device type as described herein. However, computing device 100 may be alternatively implemented as a tablet computer, a laptop computing device, a desktop computing device and/or a wearable computing device, among other possibilities. Computing device 100 may include various elements, such as body 102, display 106, and buttons 108 and 110. Computing device 100 may further include one or more cameras, such as front-facing camera 104 and one or more rear-facing cameras 112. Each of the rear-facing cameras may have a different field of view. For example, the rear facing cameras may include a wide angle camera, a main camera, and a telephoto camera.

Front-facing camera 104 may be positioned on a side of body 102 typically facing a user while in operation (e.g., on the same side as display 106). Rear-facing camera 112 may be positioned on a side of body 102 opposite front-facing camera 104. Referring to the cameras as front and rear facing is arbitrary, and computing device 100 may include multiple cameras positioned on various sides of body 102. In some examples, computing device 100 may communicate with and/or control one or more cameras remote from the computing device 100 as well or instead.

Display 106 could represent a cathode ray tube (CRT) display, a light emitting diode (LED) display, a liquid crystal (LCD) display, a plasma display, an organic light emitting diode (OLED) display, or any other type of display known in the art. In some examples, display 106 may display a digital representation of the current image being captured by front-facing camera 104 and/or rear-facing camera 112, an image that could be captured by one or more of these cameras, an image that was recently captured by one or more of these cameras, and/or a modified version of one or more of these images. Thus, display 106 may serve as a viewfinder for the cameras. Display 106 may also support touchscreen functions that may be able to adjust the settings and/or configuration of one or more aspects of computing device 100.

Front-facing camera 104 may include an image sensor and associated optical elements such as lenses. Front-facing camera 104 may offer zoom capabilities or could have a fixed focal length. In other examples, interchangeable lenses could be used with front-facing camera 104. Front-facing camera 104 may have a variable mechanical aperture and a mechanical and/or electronic shutter. Front-facing camera 104 also could be configured to capture still images, video images, or both. Further, front-facing camera 104 could represent, for example, a monoscopic, stereoscopic, or multiscopic camera. Rear-facing camera 112 may be similarly or differently arranged. Additionally, one or more of front-facing camera 104 and/or rear-facing camera 112 may be an array of one or more cameras.

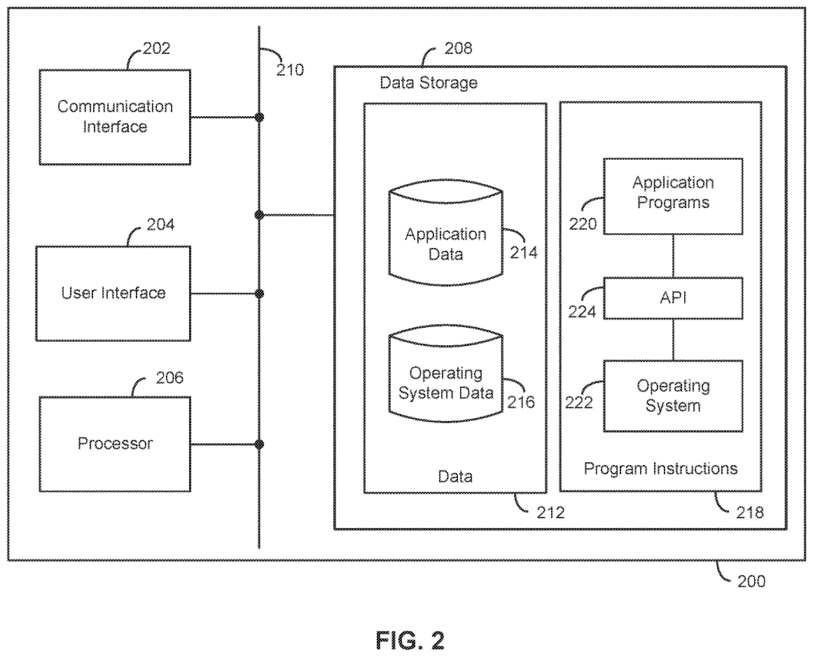

FIG. 2 is a simplified block diagram showing some of the components of an example computing system 200. By way of example and without limitation, computing system 200 may be a cellular mobile telephone (e.g., a smartphone), a computer (such as a desktop, notebook, tablet, server, or handheld computer), a home automation component, a digital video recorder (DVR), a digital television, a remote control, a wearable computing device, a gaming console, a robotic device, a vehicle, or some other type of device. Computing system 200 may represent, for example, aspects of computing device 100.

As shown in FIG. 2, computing system 200 may include communication interface 202, user interface 204, processor 206, and data storage 208, all of which may be communicatively linked together by a system bus, network, or other connection mechanism 210.

Communication interface 202 may allow computing system 200 to communicate, using analog or digital modulation, with other devices, access networks, and/or transport networks. Thus, communication interface 202 may facilitate circuit-switched and/or packet-switched communication, such as plain old telephone service (POTS) communication and/or Internet protocol (IP) or other packetized communication. For instance, communication interface 202 may include a chipset and antenna arranged for wireless communication with a radio access network or an access point. Also, communication interface 202 may take the form of or include a wireline interface, such as an Ethernet, Universal Serial Bus (USB), or High-Definition Multimedia Interface (HDMI) port, among other possibilities. Communication interface 202 may also take the form of or include a wireless interface, such as a Wi-Fi, BLUETOOTH®, global positioning system (GPS), or wide-area wireless interface (e.g., WiMAX or 3GPP Long-Term Evolution (LTE)), among other possibilities. However, other forms of physical layer interfaces and other types of standard or proprietary communication protocols may be used over communication interface 202. Furthermore, communication interface 202 may comprise multiple physical communication interfaces (e.g., a Wi-Fi interface, a BLUETOOTH® interface, and a wide-area wireless interface).

User interface 204 may function to allow computing system 200 to interact with a human or non-human user, such as to receive input from a user and to provide output to the user. Thus, user interface 204 may include input components such as a keypad, keyboard, touch-sensitive panel, computer mouse, trackball, joystick, microphone, and so on. User interface 204 may also include one or more output components such as a display screen, which, for example, may be combined with a touch-sensitive panel. The display screen may be based on CRT, LCD, LED, and/or OLED technologies, or other technologies now known or later developed. User interface 204 may also be configured to generate audible output(s), via a speaker, speaker jack, audio output port, audio output device, earphones, and/or other similar devices. User interface 204 may also be configured to receive and/or capture audible utterance(s), noise(s), and/or signal(s) by way of a microphone and/or other similar devices.

In some examples, user interface 204 may include a display that serves as a viewfinder for still camera and/or video camera functions supported by computing system 200. Additionally, user interface 204 may include one or more buttons, switches, knobs, and/or dials that facilitate the configuration and focusing of a camera function and the capturing of images. It may be possible that some or all of these buttons, switches, knobs, and/or dials are implemented by way of a touch-sensitive panel.

Processor 206 may comprise one or more general purpose processors—e.g., microprocessors—and/or one or more special purpose processors—e.g., digital signal processors (DSPs), graphics processing units (GPUs), floating point units (FPUs), network processors, or application-specific integrated circuits (ASICs). In some instances, special purpose processors may be capable of image processing, image alignment, and merging images, among other possibilities. Data storage 208 may include one or more volatile and/or non-volatile storage components, such as magnetic, optical, flash, or organic storage, and may be integrated in whole or in part with processor 206. Data storage 208 may include removable and/or non-removable components.

Processor 206 may be capable of executing program instructions 218 (e.g., compiled or non-compiled program logic and/or machine code) stored in data storage 208 to carry out the various functions described herein. Therefore, data storage 208 may include a non-transitory computer-readable medium, having stored thereon program instructions that, upon execution by computing system 200, cause computing system 200 to carry out any of the methods, processes, or operations disclosed in this specification and/or the accompanying drawings. The execution of program instructions 218 by processor 206 may result in processor 206 using data 212.

By way of example, program instructions 218 may include an operating system 222 (e.g., an operating system kernel, device driver(s), and/or other modules) and one or more application programs 220 (e.g., camera functions, address book, email, web browsing, social networking, audio-to-text functions, text translation functions, and/or gaming applications) installed on computing system 200. Similarly, data 212 may include operating system data 216 and application data 214. Operating system data 216 may be accessible primarily to operating system 222, and application data 214 may be accessible primarily to one or more of application programs 220. Application data 214 may be arranged in a file system that is visible to or hidden from a user of computing system 200.

Application programs 220 may communicate with operating system 222 through one or more application programming interfaces (APIs) 224. These APIs 224 may facilitate, for instance, application programs 220 reading and/or writing application data 214, transmitting or receiving information via communication interface 202, receiving and/or displaying information on user interface 204, and so on.

In some cases, application programs 220 may be referred to as “apps” for short. Additionally, application programs 220 may be downloadable to computing system 200 through one or more online application stores or application markets. However, application programs can also be installed on computing system 200 in other ways, such as via a web browser or through a physical interface (e.g., a USB port) on computing system 200.

### III. MEMORY COMPATIBILITY LAYER FOR API CAPTURE

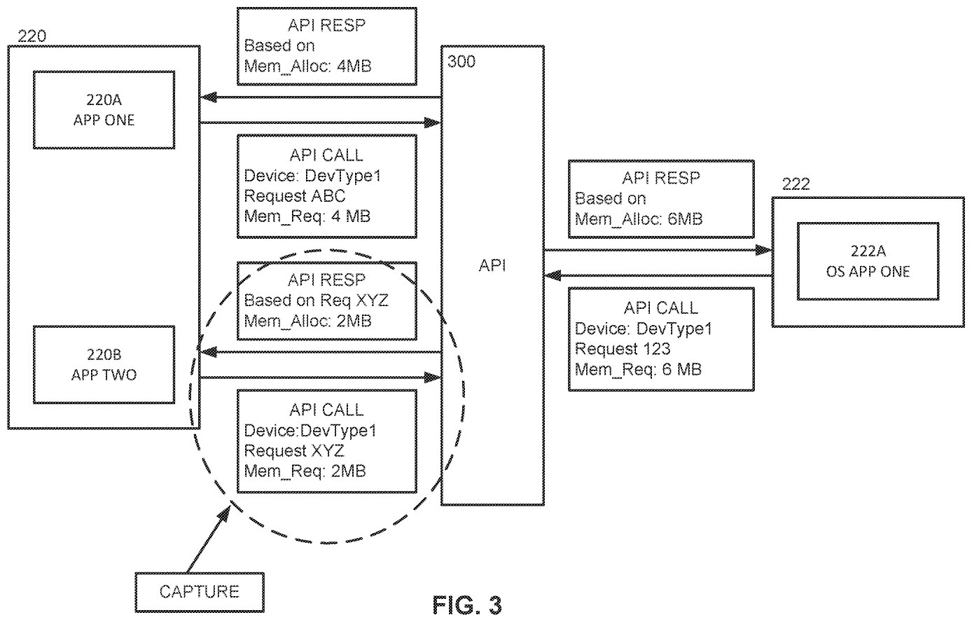

FIG. 3 is a simplified block diagram showing interactions between an example of the APIs 224, identified as API 300, with, for example, elements of the application programs 220 and/or operating system 222. As shown in FIG. 3, the elements of the application programs 220 and/or operating system 222 generate one or more calls directed to the API 300 and receive a corresponding response from the API 300 for each of the respective calls. In operation, each of the calls may be used to determine memory requirements for the requested operation. The calls when taken together may be utilized to generate and display one or more elements of digital content, such as graphical content.

FIG. 3 illustrates that individual applications App One 220A and App Two 220B operating as part of the application programs 220 may make individual calls to the API 300. In response to these individual calls, the API 300 may generate a response for each call providing the requested operations, information, and/or elements of the digital content. Similarly, OS App One 222A operating as part of the operating system 222 may make one or more calls to the API 300. In response to these calls, the API 300 may generate a response and provide the requested digital content, operation and/or information. In each of these cases, the calls to API 300 may specify and manage the memory requirements associated with the requested operation. For example, App Two 220B may make a call to API 300 that includes a memory request. The memory request may reflect a memory allocation associated with the requested operation. For example, the memory request may specify an allocation size and allocation alignment for each requested operation.

As illustrated in FIG. 3, the call to API 300 made from App Two 220B may include a memory request specifying a 2 MB size. In response to the 2 MB memory request included in the call from App Two 220B, the API 300 provides a response including a memory allocation corresponding to the 2 MB request. Similarly, example calls from App One 220A and OS App One 222A include memory requests of 4 MB and 6 MB, respectively. In response to the calls from App One 220A and OS App One 222A, the API 300 provides a response including an appropriate memory allocation. For example, the API response associated with App One 220A includes a memory allocation of 4 MB as requested, and the API response associated with OS App One 222A includes a memory allocation of 6 MB as requested. In each case, the memory request may reflect the requirements associated with hardware such as the processor 206 and software such as a device driver.

In some embodiments, the call to API 300 made from App Two 220B including the memory request specifying a 2 MB size may be captured or otherwise recorded for playback. As indicated in each of the API calls shown in FIG. 3, the computing device 100 may be a device type corresponding to DevType1. The device type may reflect the hardware and software requirements of computing device 100 and any other similarly configured device. Accordingly, devices corresponding to DevType1 or of similar configuration may be expected to playback the captured call to API 300 made from App Two 220B including the memory request specifying a 2 MB size. However, devices configured according to a different device type, i.e., devices having hardware and software requirements different than those of computing device 100, may not experience reliable playback of the captured call to API 300 made from App Two 220B because the specified 2 MB memory request may be incompatible based on different hardware and software requirements.

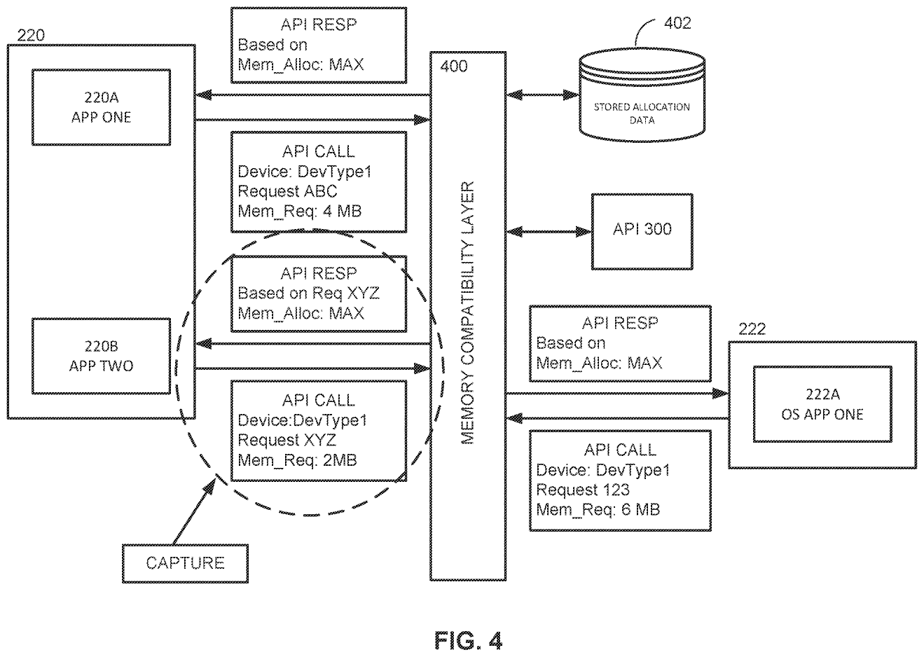

FIG. 4 is a simplified block diagram configured to provide memory compatibility across device types between the API 300 and elements of the application programs 220 and/or operating system 222 in accordance with disclosed examples. In order to provide memory compatibility across one or more different device types, a memory compatibility layer 400 may be established in connection with the API 300. As shown in FIG. 4, the memory compatibility layer 400 may be configured to intercept each of the memory related calls generated by elements of the application programs 220 and/or operating system 222 and directed to the API 300. For example, the call generated by App Two 220B operating as part of application programs 220 may be intercepted by the memory compatibility layer 400.

The memory compatibility layer 400 may route the intercepted request XYZ to the API 300 for implementation. The memory compatibility layer 400 may further utilize the device type and memory request specified in the call to access the stored allocation data 402. In some embodiments, the stored allocation data 402 may be maintained in a table specifying one or more of a memory request, a maximum allocation, a memory alignment organized by device type. For example, the table may contain requested size and requested memory type information for each of the memory requests and have mapping values of size and alignment returned by the driver for the devices. Table 1 is an example of maintained allocation data for 2 devices (DeviceID 0, and DeviceID 1) including a requested size, a requested type, a returned size, and a returned alignment. The stored allocation data 402 may further be maintained to ensure that any detected increase in the memory request for a given device type results in an update to the maximum allocation maintained in the table. In this way, the stored allocation data 402 may be continually updated to reflect the maximum memory request and memory allocation for each device type.

TABLE 1

| | Requested | Requested | Returned | Returned |
|---|---|---|---|---|
| DeviceID | Size | Type | Size | Aligament |
| 0 | 1024 | 0 | 1024 | 16 |
| 0 | 2000 | 0 | 2048 | 16 |
| 0 | 2000 | 1 | 2048 | 256 |
| 1 | 1024 | 0 | 2048 | 8 |
| 1 | 2000 | 0 | 2048 | 8 |
| 1 | 2000 | 1 | 2048 | 8 |

The memory compatibility layer 400 may return a memory allocation from the stored allocation data 402 that reflects a maximum allocation for a requested object (e.g., a particular type of graphical object to generate for display as part of a video game). The returned memory allocation may, as illustrated in Table 2, be generated for each of the three requests shown in FIG. 4. The returned memory allocation provided in Table 2 may include a requested size, a requested type, a returned size, and a returned alignment. In this example, the returned memory allocation reflects the lowest common denominator from different devices. For example, the memory compatibility layer 400 may further append the returned maximum allocation into the response generated by the API 300 to request XYZ.

TABLE 2

| Requested | Requested | Returned | Returned |
|---|---|---|---|
| Size | Type | Size | Alignment |
| 1024 | 0 | 2048 | 16 |
| 2000 | 0 | 2048 | 16 |
| 2000 | 1 | 2048 | 256 |

In this configuration, the call to API 300 made from App Two 220B including the memory request specifying a 2 MB size results in a response to request XYZ and a memory allocation. For example, if the maximum allocation equaled the memory request, then 2 MB would be returned as part of the response generated by API 300. Alternatively, if the maximum allocation for the requested object was 8 MB, then the memory request is replaced by the maximum allocation and 8 MB is returned as part of the response generated by API 300. Similarly, if the call to API 300 made from App Two 220 were captured as indicated in FIG. 4 and subsequently replayed by a device corresponding to a device type of DevType2, the response provided by the memory compatibility layer 400 would include a maximum allocation associated with device type of DevType2. For example, based on the hardware and software configuration associated with device type DevType2, the maximum allocation provided may be 4 MB. In this way, the memory allocation layer 400 provides the maximum allocation for each device type along with a response to request XYZ.

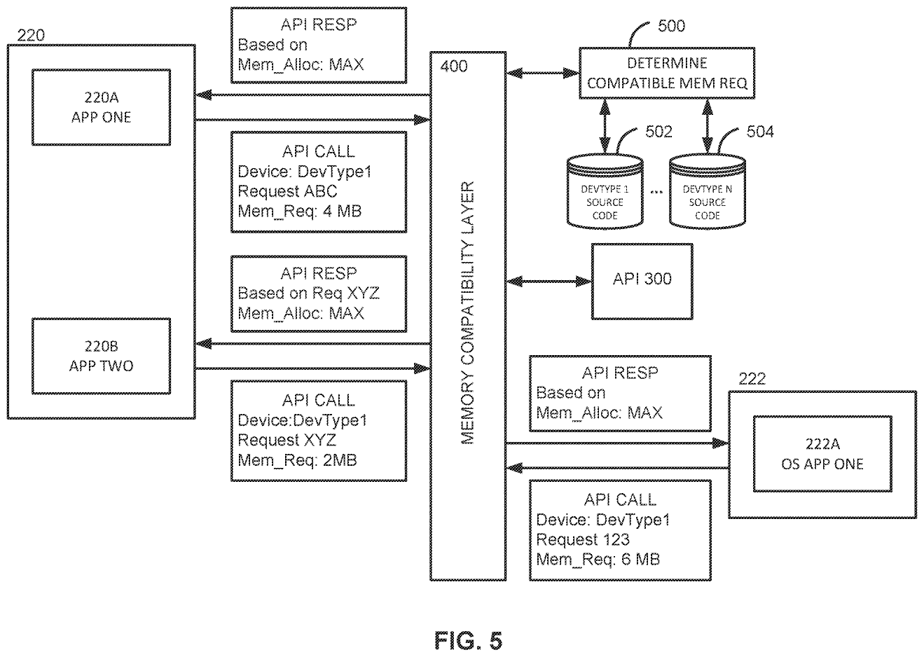

FIG. 5 is a simplified block diagram configured to provide memory compatibility across device types between the API 300 and elements of the application programs 220 and/or operating system 222 in accordance with additional disclosed examples. As shown in FIG. 5, the memory compatibility layer 400 may be configured to intercept each of the memory related calls generated by elements of the application programs 220 and/or operating system 222 and directed to the API 300. In this embodiment, a call made to the API 300 may be intercepted by the memory compatibility layer 400. For example, the memory compatibility layer 400 may route the intercepted request XYZ to the API 300 for implementation. The memory compatibility layer 400 may further utilize the device type and memory request to determine compatible memory requirements 500.

In order to determine compatible memory requirements 500, the memory compatibility layer 400 may retrieve a version of source code for each of the device types for which memory compatibility is desired. The source code 502, 504 may correspond to a device driver associated with each of the different device types DevType1, DevTypeN. The retrieved source code 502, 504 may be analyzed to make sure that a compatible memory allocation is defined across each of the different device types DevType1, DevTypeN. For example, an allocation for each source code 502, 504 may be identified based on the requirements of a respective device driver and the largest identified allocation may be designated as the maximum allocation. The maximum allocation designated in this matter is a compatible memory allocation for each of the different device types DevType1, DevTypeN.

The memory compatibility layer 400 may append the identified maximum allocation into the response generated by the API 300 to request XYZ. The resulting response is compatible across each of the different device types DevType1, DevTypeN. In some embodiments, device types to be used to determine compatible memory requirements 500 may be selected or identified for consideration. Selection may occur through a user interface allowing identification of devices by device type, hardware configurations, or other characteristics.

In this configuration, the call to API 300 made from App One 220A, App Two 220B, and OS App One 222A may specify a particular memory request. The response generated by the API 300 to the calls made from App One 220A, App Two 220B, and OS App One 222A may reflect a memory allocation determined by the memory compatibility layer 400. In particular, the memory allocation included in each response may reflect a maximum allocation compatible memory across each of the different device types DevType1, DevTypeN.

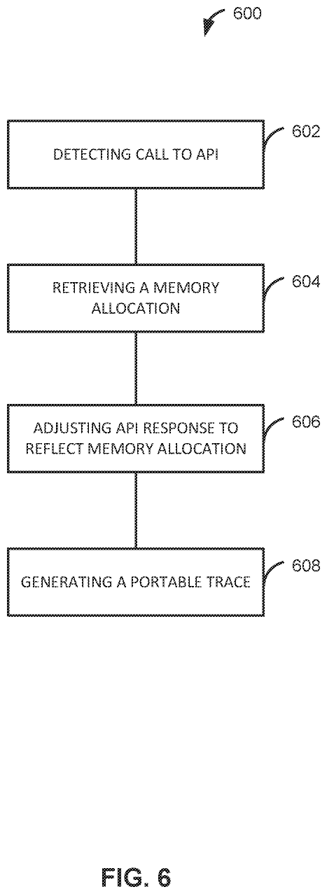

FIG. 6 is a block diagram of a method, in accordance with example embodiments. Blocks 602, 604, 606, and 608 may collectively be referred to as method 600. In some examples, method 600 may be executed by one or more computing systems (e.g., computing system 200 of FIG. 2) and/or one or more processors (e.g., processor 206 of FIG. 2). In further examples, method 600 may be carried out on a computing device, such as computing device 100 of FIG. 1. Execution of method 600 may involve a computing device or server device remote from computing device 100. Other computing devices may also be used in the performance of method 600. The one or more computing devices and/or one or more computing systems used in the execution of method 600 may be collectively referred to herein as a “computing system.”

Those skilled in the art will understand that the block diagram of FIG. 6 illustrates functionality and operation of certain implementations of the present disclosure. In this regard, each block of the block diagram may represent a module, a segment, or a portion of program code, which includes one or more instructions executable by one or more processors for implementing specific logical functions or steps in the process. The program code may be stored on any type of computer readable medium, for example, such as a storage device including a disk or hard drive.

In addition, each block may represent circuitry that is wired to perform the specific logical functions in the process. Alternative implementations are included within the scope of the example implementations of the present application in which functions may be executed out of order from that shown or discussed, including substantially concurrent or in reverse order, depending on the functionality involved, as would be understood by those reasonably skilled in the art.

At block 602, method 600 includes detecting, by a memory compatiblity layer running on a device capturing digital content for replay, a call directed to an application programming interface. The digital content may include graphical content, such as video game content. In further examples, the digital content may relate to other types of processing, such as the execution of one or more machine-learned models. The call may specify a memory allocation based on the device. The memory allocation may be based on a driver version associated with the device. The device may correspond to one of a plurality of device types. The plurality of device types may make up a set of desired replay devices for the captured digital content. In some examples, the capture device is a mobile phone, a tablet computer, a laptop computing device, or a desktop computing device. Each device type may specify at least one of a driver version, a memory requirement, or a memory alignment. In some examples, the plurality of device types correspond to a plurality of mobile phone models. The memory compatibility layer may be implemented in a testing environment.

At block 604, method 600 includes, in response to the detected call, retrieving, by the memory compatibility layer, a maximum memory allocation from a plurality of memory allocations associated with the application programming interface. The plurality of memory allocations may correspond to the plurality of device types.

In some examples, the memory compatibility layer builds a table of objects and corresponding memory allocations associated with each of the plurality of device types. The maximum memory allocation is then based on a particular object and corresponding memory allocation associated with each of the plurality of device types from the table. In such examples, the table may be determined and stored in advance of capturing the digital content for replay.

In alternative examples, the memory compatibility layer identifies a driver source code associated with each of the plurality of device types. The maximum memory allocation is then based on the driver source code associated with each of the plurality of device types. In such examples, the driver source code may be stored as part of the device capturing the digital content for replay. Alternatively, the driver source code may be accessible on a network in communication with the device capturing the digital content for replay.

At block 606, method 600 includes adjusting, by the memory compatibility layer, a response from the application programming interface to accommodate the maximum memory allocation from the plurality of memory allocations.

At block 608, method 600 includes, based on the adjusted response from the application programming interface, generating a portable trace for replay of the digital content on a replay device of one of the plurality of device types. The memory compatibility layer may therefore enable replay of the digital content on any device of the plurality of device types.

In some examples, a user interface may be provided to allow a user to select the plurality of desired replay devices for a particular capture and replay application.

In addition or instead of allocating an amount of memory, the memory compatibility layer can specify a memory alignment from a plurality of memory alignments associated with the application programming interface. The plurality of memory alignments may correspond to the plurality of device types. The response from the application programming interface may then be adjusted based on the memory alignment. Similar to the amount of memory, the selected memory alignment may be chosen as a least common denominator to enable replay of the captured digital on any device from a set of desired replay devices.

Some examples described herein may involve memory allocation API calls to implement one or more machine-learned models. A machine-learned model as described herein may include, but is not limited to: an artificial neural network (e.g., a convolutional neural network, a recurrent neural network, a Bayesian network, a hidden Markov model, a Markov decision process, a logistic regression function, a suitable statistical machine-learning algorithm, and/or a heuristic machine-learning system), a support vector machine, a regression tree, an ensemble of regression trees (also referred to as a regression forest), a decision tree, an ensemble of decision trees (also referred to as a decision forest), or some other machine-learning model architecture or combination of architectures.

An artificial neural network (ANN) could be configured in a variety of ways. For example, the ANN could include two or more layers, could include units having linear, logarithmic, or otherwise-specified output functions, could include fully or otherwise-connected neurons, could include recurrent and/or feed-forward connections between neurons in different layers, could include filters or other elements to process input information and/or information passing between layers, or could be configured in some other way to facilitate the generation of predicted outputs, such as output images.

An ANN could include one or more filters that could be applied to the input and the outputs of such filters could then be applied to the inputs of one or more neurons of the ANN. For example, such an ANN could be or could include a convolutional neural network (CNN). Convolutional neural networks are a variety of ANNs that are configured to facilitate ANN-based classification or other processing based on images or other large-dimensional inputs whose elements are organized within two or more dimensions. The organization of the ANN along these dimensions may be related to some structure in the input structure (e.g., as relative location within the two-dimensional space of an image can be related to similarity between pixels of the image).

A CNN or other variety of ANN could include multiple convolutional layers (e.g., corresponding to respective different filters and/or features), pooling layers, rectification layers, fully connected layers, or other types of layers. Convolutional layers of a CNN represent convolution of an input image, or of some other input (e.g., of a filtered, downsampled, or otherwise-processed version of an input image), with a filter. Pooling layers of a CNN apply non-linear downsampling to higher layers of the CNN, e.g., by applying a maximum, average, L2-norm, or other pooling function to a subset of neurons, outputs, or other features of the higher layer(s) of the CNN. Rectification layers of a CNN apply a rectifying nonlinear function (e.g., a non-saturating activation function, a sigmoid function) to outputs of a higher layer. Fully connected layers of a CNN receive inputs from many or all of the neurons in one or more higher layers of the CNN. The outputs of neurons of one or more fully connected layers (e.g., a final layer of an ANN or CNN) could be used to determine information about areas of an input image (e.g., for each of the pixels of an input image) or for the image as a whole.

Neurons in a CNN can be organized according to corresponding dimensions of the input. For example, where the input is an image (a two-dimensional input, or a three-dimensional input where the color channels of the image are arranged along a third dimension), neurons of the CNN (e.g., of an input layer of the CNN, of a pooling layer of the CNN) could correspond to locations in the two-dimensional input image. Connections between neurons and/or filters in different layers of the CNN could be related to such locations. For example, a neuron in a convolutional layer of the CNN could receive an input that is based on a convolution of a filter with a portion of the input image, or with a portion of some other layer of the CNN, that is at a location proximate to the location of the convolutional-layer neuron. In another example, a neuron in a pooling layer of the CNN could receive inputs from neurons, in a layer higher than the pooling layer (e.g., in a convolutional layer, in a higher pooling layer), that have locations that are proximate to the location of the pooling-layer neuron.

In general, application of a machine-learned model may involve one or more memory allocation API calls which may be device-dependent. For instance, an amount of memory may be allocated to execute a particular type of machine-learned model and/or a particular portion (e.g., layer) of a machine-learned model. Utilizing the methodology described herein, an amount of memory allocated may correspond to a maximum memory allocation for a particular device type of a set of desired replay device types to enable the device type to execute the machine-learned model and/or the particular portion (e.g., layer) of the machine-learned model. Such memory allocations may be dependent on the type of GPU associated with each device type. The methodology described herein may therefore be expanded to enable the testing of machine learning inference captured on one device and replayed on a different device.

### IV. CONCLUSION

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. In the figures, similar symbols typically identify similar components, unless context dictates otherwise. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information may correspond to circuitry that can be configured to perform the specific logical functions of a herein-described method or technique. Alternatively or additionally, a block that represents a processing of information may correspond to a module, a segment, or a portion of program code (including related data). The program code may include one or more instructions executable by a processor for implementing specific logical operations or actions in the method or technique. The program code and/or related data may be stored on any type of computer readable medium such as a storage device including random access memory (RAM), a disk drive, a solid state drive, or another storage medium.

The computer readable medium may also include non-transitory computer readable media such as computer readable media that store data for short periods of time like register memory, processor cache, and RAM. The computer readable media may also include non-transitory computer readable media that store program code and/or data for longer periods of time. Thus, the computer readable media may include secondary or persistent long term storage, like read only memory (ROM), optical or magnetic disks, solid state drives, compact-disc read only memory (CD-ROM), for example. The computer readable media may also be any other volatile or non-volatile storage systems. A computer readable medium may be considered a computer readable storage medium, for example, or a tangible storage device.

Moreover, a step or block that represents one or more information transmissions may correspond to information transmissions between software and/or hardware modules in the same physical device. However, other information transmissions may be between software modules and/or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for the purpose of illustration and are not intended to be limiting, with the true scope being indicated by the following claims.

1. A method comprising:
detecting, by a memory compatibility layer running on a device capturing digital content for replay, a call directed to an application programming interface, wherein the call specifies a memory allocation based on the device, wherein the device corresponds to one of a plurality of device types;
in response to the detected call, retrieving, by the memory compatibility layer, a maximum memory allocation from a plurality of memory allocations associated with the application programming interface, wherein the plurality of memory allocations correspond to the plurality of device types;
adjusting, by the memory compatibility layer, a response from the application programming interface to accommodate the maximum memory allocation from the plurality of memory allocations; and
based on the adjusted response from the application programming interface, generating a portable trace for replay of the digital content on a replay device of one of the plurality of device types.

2. The method of claim 1, wherein the digital content captured for replay comprises graphical content.

3. The method of claim 2, wherein the graphical content is associated with a video game.

4. The method of claim 1, wherein the digital content captured for replay comprises content to enable one or more machine learned models.

5. The method of claim 1, wherein the memory compatibility layer is implemented in a testing environment.

6. The method of claim 1, wherein the device is a mobile phone, a tablet computer, a laptop computing device, or a desktop computing device.

7. The method of claim 1, wherein the plurality of device types correspond to a plurality of mobile phone models.

8. The method of claim 1, wherein the memory allocation is based on a driver version associated with the device.

9. The method of claim 1, wherein the device type specifies at least one of a driver version, a memory requirement, or a memory alignment.

10. The method of claim 1, wherein the memory compatibility layer builds a table of objects and corresponding memory allocations associated with each of the plurality of device types, wherein the maximum memory allocation is based on a particular object and corresponding memory allocation associated with each of the plurality of device types from the table.

11. The method of claim 10, wherein the table is determined and stored in advance of capturing the digital content for replay.

12. The method of claim 1, wherein the memory compatibility layer identifies a driver source code associated with each of the plurality of device types, wherein the maximum memory allocation is based on the driver source code associated with each of the plurality of device types.

13. The method of claim 12, wherein the driver source code is stored as part of the device capturing the digital content for replay.

14. The method of claim 12, wherein the driver source code is accessible on a network in communication with the device capturing the digital content for replay.

15. The method of claim 1, wherein the plurality of device types are specified via a user interface displayed on the device.

16. The method of claim 1, further comprising retrieving, by the memory compatibility layer, a memory alignment from a plurality of memory alignments associated with the application programming interface, wherein the plurality of memory alignments correspond to the plurality of device types, wherein the response from the application programming interface is further adjusted based on the memory alignment.

17. A device, comprising:
at least one processor configured to execute instructions stored in a memory of the device, wherein the instructions are executable to:
detect, by a memory compatibility layer running on the device, a call directed to an application programming interface, wherein the call specifies a memory allocation based on the device, wherein the device corresponds to one of a plurality of device types;
in response to the detected call, retrieve, by the memory compatibility layer, a maximum memory allocation from a plurality of memory allocations associated with the application programming interface, wherein the plurality of memory allocations correspond to the plurality of device types;
adjust, by the memory compatibility layer, a response from the application programming interface to accommodate the maximum memory allocation from the plurality of memory allocations; and
based on the adjusted response from the application programming interface, generate a portable trace for replay of the digital content on a replay device of one of the plurality of device types.

18. The device of claim 17, wherein the instructions are further executable to retrieve, by the memory compatibility layer, a memory alignment from a plurality of memory alignments associated with the application programming interface, wherein the plurality of memory alignments correspond to the plurality of device types, wherein the response from the application programming interface is further adjusted based on the memory alignment.

19. A non-transitory computer readable medium storing program instructions executable by one or more processors to cause the one or more processors to perform operations comprising:
detecting, by a memory compatibility layer running on a device capturing digital content for replay, a call directed to an application programming interface, wherein the call specifies a memory allocation based on the device, wherein the device corresponds to one of a plurality of device types;
in response to the detected call, retrieving, by the memory compatibility layer, a maximum memory allocation from a plurality of memory allocations associated with the application programming interface, wherein the plurality of memory allocations correspond to the plurality of device types;
adjusting, by the memory compatibility layer, a response from the application programming interface to accommodate the maximum memory allocation from the plurality of memory allocations; and
based on the adjusted response from the application programming interface, generating a portable trace for replay of the digital content on a replay device of one of the plurality of device types.

20. The non-transitory computer readable medium of claim 19, wherein the operations further comprise retrieving, by the memory compatibility layer, a memory alignment from a plurality of memory alignments associated with the application programming interface, wherein the plurality of memory alignments correspond to the plurality of device types, wherein the response from the application programming interface is further adjusted based on the memory alignment.
